(19) United States
(12) Patent Application Publication
(10) Pub. No.: US 2012/0206938 A1
(43) Pub. Date: Aug. 16, 2012

(54) LIGHT-GUIDE FOR AN ILLUMINATION SYSTEM AND FOR A SCANNING BACKLIGHT SYSTEM

(75) Inventors: Gabriel-Eugen Onac, Eindhoven (NL); Marcellinus Petrus Carolus Michael Krijn, Eindhoven (NL)

(73) Assignee: KONINKLIJKE PHILIPS ELECTRONICS N.V., EINDHOVEN (NL)

(21) Appl. No.: 13/503,445

(22) PCT Filed: Oct. 25, 2010
(86) PCT No.: PCT/IB10/54811

§ 371 Date: Apr. 23, 2012

(30) Foreign Application Priority Data
Oct. 27, 2009 (EP) 09174124.9

(51) Int. Cl. F21V 8/00

(52) U.S. Cl. 362/602; 362/615; 362/629; 362/628; 362/616; 362/613

(57) ABSTRACT

The invention relates to a light-guide (100), an illumination system (200), a luminaire (400), a scanning backlight system (200) and a display device. The light-guide comprises a plurality of light-guide segments (10), each light-guide segment being substantially optically separated from a neighboring light-guide segment. Each light-guide segment comprises light-extraction means (40) for extracting at least part of the distributed light via a front wall (20) to illuminate in operation a light output window (220). A distance (D) between the front wall and the light output window being smaller at a center (C) of the front wall compared to a predefined edge (50) of the front wall. The predefined edge of the front wall is an edge at which the light-guide segment is arranged adjacent to the neighboring light-guide segment. An effect of the light-guide according to the invention is that the increased distance at the predefined edge of the front wall between the front wall and the light output window reduces local variations in intensity and/or color and/or distribution of the light due to mixing of the light before the light impinges on the light-output window.

### FIELD OF THE INVENTION

The invention relates to a light-guide for an illumination system.

The invention also relates to a luminaire, a scanning backlight system and a display device.

### BACKGROUND OF THE INVENTION

Light-guides are known per se, for example, for illuminating a light output window of an illumination system such as a backlight system. They are used, inter alia, in backlighting systems for (picture) display devices, for example, for TV sets and monitors. Such light-guides are particularly suitable for use as backlighting systems for non-emissive display devices such as liquid crystal display devices, also denoted as LCD panels, which are used in, for example, (portable) computers or, for example, (portable) telephones.

Said non-emissive display devices usually comprise a substrate provided with a regular pattern of pixels which are each controlled by at least one electrode. The display device utilizes a control circuit for achieving a picture or a data graphical display in a relevant field of a (picture) screen of the (picture) display device. The light originating from the illumination system in an LCD device is modulated by means of a switch or modulator in which, for example, various types of liquid crystal effects may be used. In addition, the display may be based on electrophoretic or electromechanical effects.

To reduce motion artifacts scanning backlight systems are developed and are being further improved. Scanning backlight systems are configured to sequentially illuminate a predefined group of pixels of the display device. Currently, there are two commonly used configurations for scanning backlight systems for non-emissive display devices: the edge-lit configuration and the direct-lit configuration. In the edge-lit configuration, the scanning backlight system generally comprises a light-guide arranged parallel to the light output window and having an edge wall through which an (array) of light sources emit light into the light-guide. The light is guided substantially parallel to the light output window and is distributed throughout the light-guide. The light-guide comprises a plurality of light-guide segments which correspond to the area of pixels of the predefined group of pixels which are sequentially illuminated by the scanning backlight system. In such an edge-lit configuration, the predefined group of pixels constitutes a (plurality of) line(s) of pixels across the display device which generates a one-dimensional scanning backlight system. The light is emitted through the light output window by redirecting part of the guided light via light-extraction means.

In the direct-lit configuration, the light sources are arranged in an array substantially parallel to the light output window of the scanning backlight system. In the direct-lit configuration, the scanning backlight system may be a two-dimensional scanning backlight system in which the predefined group of pixels of the display device which are sequentially illuminated may be part of a two-dimensional array of predefined groups of pixels constituting the display device.

A drawback of known light-guides having a plurality of light-guide segments is that an image displayed by a display device having such light-guides may comprise local image imperfections.

### OBJECT AND SUMMARY OF THE INVENTION

It is an object of the invention to provide a light-guide for an illumination system in which local image imperfections are reduced.

According to a first aspect of the invention the object is achieved with a light-guide for an illumination system comprising a light output window. The light-guide comprises a light output window and comprises a plurality of light-guide segments, each light-guide segment being substantially optically separated from a neighboring light-guide segment. Each light-guide segment comprises a front wall arranged opposite a rear wall and being configured for distributing the light within the light-guide segment. Each light-guide segment further comprises light-extraction means for extracting at least part of the distributed light via the front wall to illuminate in operation the light output window. A distance between the front wall and the light output window is smaller at a center of the front wall compared to a predefined edge of the front wall. The predefined edge of the front wall is an edge at which the light-guide segment is arranged adjacent to the neighboring light-guide segment.

The distance between the light output window and the front wall is a dimension which is measured in a direction substantially perpendicular to the light output window. The light output window may be a window constituted by translucent material through which the light-guide emits its light away from the light-guide. Alternatively, the light output window may, for example, comprise an imaginary planar surface which, for example, may be a tangent plane contacting the front wall substantially at the center of the front wall or an imaginary planar surface which is substantially parallel to the tangent plane which contacts the front wall substantially at the center of the front wall. The front wall of the light-guide segment is configured for emitting the light guided by the light-guide segment. The front wall comprises predefined edges being a border or line separating neighboring light-guide segments. The front wall comprises a shape such that the distance between the front wall and the light output wall at the center of the front wall is smaller compared to the predefined edge. The center of the front wall is a part of the front wall which has substantially equal distance to the edges of the front wall measured along the surface of the front wall. In case the light-guide segment has a symmetry axis parallel to the front wall, the front wall typically only has a maximum of two predefined edges and has a center substantially coinciding with a line of the front wall surface which runs substantially parallel to this symmetry axis. If the light-guide segments are arranged in the illumination system in a one-dimensional array of light-guide segments, each light guide segment comprises a maximum of two predefined edges. If the light-guide segments are arranged in the illumination system in a two-dimensional array of light-guide segments, each light-guide segment comprises a maximum of four predefined edges.

The effect of the light-guide according to the invention is that the distance between the front wall and the light output window is larger at the predefined edge where the light-guide segment adjoins the neighboring light-guide segment compared to the center of the front wall of the light-guide segment. Due to this increased distance, local variations in intensity and/or color and/or distribution of the light at the interface between adjacent light-guide segments are averaged out due to mixing of the light originating from both of the adjacent light-guide segments before the light impinges on the light-output window. Consequently, due to the increasing of the distance at the predefined edge, visibility of variations at the interface between neighboring light-guide segments are reduced, improving the uniformity across the light output window of the illumination system. When the illumination system is a scanning backlight system, the increasing of the distance at the predefined edge improves the quality of the image produced on a display device comprising the scanning backlight system comprising the light-guide.

Especially light artifacts which result in substantially straight lines typically are clearly visible by a user, because the human eye is relatively sensitive to small brightness variations. Imperfections at the edges of the front wall may cause unwanted scatter effects which may cause visible intensity variations in, for example, an image illuminated via the illumination system such as the scanning backlight system comprising the light-guide. Also variations in intensity and/or color and/or distribution of the light between the light emitted by the light-guide segment and its neighboring light-guide segment may be visible as a line or area of deviating intensity and/or color and/or distribution in the image illuminated via illumination system such as the scanning backlight system comprising the light-guide. The inventors have found that by increasing the distance of the predefined edge to the light output window compared to the center of the front wall, any light artifacts caused by imperfections at the edge of the front wall are reduced due to additional mixing of the light emitted at the predefined edge caused by the additional distance. The increased distance at the predefined edge also causes a predefined overlap of the light emitted by the light-guide segment and the neighboring light-guide segment. This predefined overlap reduces any variations in intensity and/or color and/or distribution of the light between adjacent light-guide segments in the light-guide which also improve the quality of, for example, the image produced on the display device comprising the scanning backlight system comprising the light-guide. Also misalignment between two neighboring light-guide segments may generate local intensity variations which typically result in visible straight lines of deviating intensity and which may be significantly reduced by increasing the distance at the predefined edge to generate the predefined overlap.

The light-guide segment may, for example, be constituted by solid material substantially transparent for the light which is to be guided by the light-guide. The guiding and mixing of the light may, for example, occur via total internal reflection which generates a substantially loss-less confinement of the light inside the light-guide segment. The light extraction means ensure that the light is extracted from each light-guide segment such that the light output window of the illumination system is illuminated substantially homogeneously. When the illumination system is a scanning backlight system the light intensity which impinges on the light output window is homogeneous across the light output window during a predefined time interval which may, for example, be a frame time of a display device such as a television.

In an embodiment of the light-guide, the light-guide is constituted by a continuous material, the increased distance at the predefined edge of each of the light-guide segments constituting the optical separation between the light-guide segments. This embodiment has as an advantage that the cost of manufacturing of the light-guide is reduced. For example, well known molding techniques such as injection-molding or extrusion techniques may be used to generate the light-guide from a continuous material. During injection-molding or extrusion a solvable or deformable material is pressed into a mold after which the solvable or deformable material is cured to form the light-guide. The shape of the front wall may be constituted to have the increased distance between the front wall and the light output window at the predefined edge compared to the center of the front wall. Also well known stamping-techniques for adapting the shape of the front wall to generate the increased distance between the front wall and the light output window at the predefined edge may be used to generate the light-guide from a continuous material.

A further advantage of this embodiment is that neighboring light-guide segments do not need to be aligned during construction of the light-guide. When the light-guide is constituted by physically separate light-guide segments, the light-guide is constructed from the separate light-guide segments by aligning the separate light-guide segments adjacent to each other. Any misalignment between two adjacent light-guide segments may cause visible light artifacts reducing the quality of the light-guide, illumination system, scanning backlight system and of the display device. Although the increased distance between the front wall at the predefined edge and the light output window reduces any light artifacts which may result from this misalignment, the current embodiment enables to construct the light-guide without the need to align the individual light-guide segments. Consequently, light artifacts due to misalignment are substantially avoided which further improve the quality of the light-guide, illumination system, scanning backlight system and display device.

An even further advantage of this embodiment is that it results in a light-guide have improved mechanical stiffness.

In an embodiment of the light-guide, a thickness of the light-guide segment at the center of the front wall is at least 3 times larger than the thickness at the predefined edge of the front wall for generating the increased distance at the predefined edge. The thickness of the light-guide segment is a dimension between the front wall and the rear wall, measured in a direction substantially perpendicular to the light output window. Having a thickness at the predefined edge which is 3 times thinner than at the center of the front-wall ensures that the light in the light-guide segment is efficiently confined within the light-guide segment. This efficient confinement is still present when the light-guide is constituted by a continuous material.

In an embodiment of the light-guide, a shape of the front wall comprises a smoothly curved shape configured for increasing the distance between the front wall and the light output window at a predefined edge compared to the distance at the center. This embodiment has as an advantage that the smoothly curved shape reduces scattering elements from occurring which may cause non-uniformities in the emission profile. Any sharp edge at or near the front wall may comprise imperfections from which light may be scattered uncontrollably and which may generate the intensity variations. A further advantage of the smoothly curved shape is that no sharp transitions occur in the angular distribution of the light which is emitted from the front wall. Such transition in angular distribution may, for example, occur between two facets which have a different orientation with respect to each other. Furthermore, the smoothly curved shape may be beneficial when using injection molding techniques to manufacture the light-guide or to manufacture the individual light-guide segments. When the front wall comprises sharp edges, these sharp edges may be locally deformed or damaged when the light-guide or the light-guide segment is released from the mold. Such deformations or damages may cause scattering of light or uncontrolled redistribution of light emitted from the light-guide or light-guide segment which may be visible in the image. Alternatively, the light-guide or light-guide segment which has relatively sharp edges may need to be cured before removing the light-guide or light-guide segment from the mold, which increases the manufacturing time of the light-guide or light-guide segment and consequently the cost of the light-guide or light-guide segment. When using a smoothly curved front wall, the sharp edges at or near the front wall may be avoided, thus improving the image quality.

In an embodiment of the light-guide, a shape of the front wall comprises a plurality of facets constituting the front wall, wherein the plurality of facets comprises an edge-facet comprising the predefined edge, the edge-facet being configured for being arranged at an angle with the light output window for increasing the distance. This embodiment has as an advantage that the increased distance between the center of the front wall and the predefined edge is generated gradually defined by the angle between the edge-facet and the light output window. Such gradual increase of the distance further reduces the visibility of any remaining differences in intensity and/or color and/or distribution of the light of neighboring light-guide segments because the mixing between the light from the light-guide segment and the light of the neighboring light-guide segment also occurs gradually. The angle between the edge-facet and the light output window is, for example, within a range between (and including) 10 degrees and 30 degrees (10 to 30, in which represents the angle) to ensure sufficient distance between the predefined edge and the light output window, while preventing a too steep variation of the distance.

Each light-guide or light-guide segment may, of course also comprise an edge wall which may be constituted by a wall or facet arranged substantially perpendicular to the light output window and arranged between, for example, the edge-facet and the rear wall. Such an edge wall increases the thickness and the strength of the light-guide or light-guide segment near the edge of the light-guide or light-guide segment which makes the light-guide or light-guide segment less vulnerable for damages at the edge of the light-guide or light-guide segment. If no edge wall would be present at the edge of the front wall or at the edge-facet of the front wall, the thickness of the light-guide or light-guide segment at the edge of the front wall may become too narrow which would increase the risk that parts of the light-guide or light-guide segment may be damaged and break off, for example, during assembly of the light-guide.

In an embodiment of the light-guide, the plurality of light-guide segments is arranged in a one-dimensional array of light-guide segments. The light-guide segments in the current embodiment typically comprise an edge wall arranged between the front wall and the rear wall in which the edge wall comprises a light-entrance window for enabling light from a light source to enter the light-guide segment. Light emitted through the light-entrance window is distributed within the light-guide segment and is subsequently used to illuminate a predefined line or a predefined number of lines of pixels in the display device. This light-guide may be used in a one-dimensional scanning backlight system in which each light-guide segment comprises an associated light source emitting light into light-guide segment via the edge wall. Alternatively, other means of coupling the light of a light source into the light-guide segment may be used, for example, by applying a concavely shaped part bulging inward into the light-guide segment, for example, from the rear wall to accommodate room for a light source, for example, a side-emitting light emitting diode in which the light from the light source is emitted in a direction substantially parallel to the light output window.

Alternatively, the plurality of light-guide segments is arranged in a two-dimensional array of light-guide segments. In such an embodiment, the light-guide segment may comprise a light-entrance window which is arranged on an edge of the light-guide segment which extends from the light-guide segment to behind the rear wall of a neighboring light-guide segment. Alternatively, the light-guide segment may comprise the concavely shaped part bulging inward into the light-guide segment, for example, from the rear wall to accommodate room for the light source, for example, a side-emitting light emitting diode in which the light from the light source is emitted in a direction substantially parallel to the light output window.

In an embodiment of the light-guide, the light-guide segment comprises a light-entrance window for enabling light from a light source to enter the light-guide segment, at least one of the light-guide segments in the plurality of light-guide segments being configured for having the light-entrance window located at a side of the rear wall of the neighboring light-guide segment facing away from the neighboring light-guide segment. In backlight systems, the light source is often arranged at an edge wall of the light-guide segment. However, such an arrangement of the light source often results in a relatively broad and thick rim around the display device which, next to the less aesthetic appearance of the display, also requires additional space when, for example, integrating the display device in a further application or housing. The current embodiment has as an advantage that the light source may be hidden away behind the rear wall of a neighboring light-guide segment.

In an embodiment of the light-guide, each light-guide segment is configured for illuminating a corresponding part of the light output window, the corresponding parts of neighboring light-guide segments are configured to partially overlap. Especially such partial overlap may be used to the advantage that any differences between the intensity and/or color and/or distribution of the light emitted by the front wall by adjacent light-guide segments is averaged out across the overlapping region to make the transition in intensity and/or color and/or distribution of light between adjacent light-guide segments to reduce gradually, thus reducing the visibility of these transition to the human eye.

In an embodiment of the light-guide, a distribution, dimension and/or density of the light-extraction means in the light-guide segment is configured for reducing an intensity of the light extracted by a single light-guide segment at the overlap between neighboring parts illuminated by neighboring light-guide segments to generate a substantially uniform illumination of the output window. By reducing the intensity at the overlap region which is contributed by a single light-guide segment, the overall intensity of the overlap may be chosen such that the overall intensity across the whole light-output window is substantially homogeneous. In the embodiment in which the light-guide is part of a scanning backlight system, the different parts together with the overlap regions are illuminated by the scanning backlight system in a sequential manner. Over time, the light emitted across the light-output window is substantially uniform.

In an embodiment of the light-guide, the light-guide comprises luminescent material or comprises a mixture of luminescent materials for converting at least part of the light guided through the light-guide into light having a longer wavelength. The luminescent material may, for example, be arranged on the front wall and/or on the rear wall of the light-guide or may be arranged on a separate substrate arranged between the light source and the light output window. Alternatively the luminescent material may be arranged on the light output window or the luminescent material may be distributed within the light-guide segment. Even further alternatively, the luminescent material may constitute the light-extraction means. Any of the previously mentioned arrangements of the luminescent material in the light-guide is also known as a remote phosphor arrangement. The benefit when having the luminescent material remote from the light source is that the efficiency of the luminescent material is improved, the range of luminescent materials to choose from is improved due to the lower temperature requirements of the luminescent material in the remote phosphor arrangement, and the remote luminescent material also acts as a diffuser which diffuses the light emitted by the light source avoiding the use of a separate diffuser.

The invention also relates to an illumination system comprising a plurality of light sources and the light-guide according to the invention.

In an embodiment of the illumination system, the plurality of light sources each emit substantially white light, and/or the plurality of light sources each comprise a plurality of light-emitters emitting light of a plurality of colors. A benefit of this embodiment is that the plurality of colors may be used to tune a color emitted by the individual light-guide segments by tuning an intensity of the light-emitters in the light source. Furthermore, when the illumination system is a scanning backlight system, the scanning backlight system may be configured for scanning each color of the plurality of colors separately. Consequently, optimized scanning settings may be applied for the different colors to reduce, for example, motion artifacts in the image. Such optimized scanning settings may, for example, comprise different scan-speed for different colors due to the use of, for example, different luminescent materials for generating the different colors which have a substantially different decay-time, or, for example, by only applying the scanning mode of operation of the scanning backlight system for a specific color rather than for all colors as motion artifacts are only to be expected at a specific color of the range of available colors or are only visible at a specific color in the range of available colors.

The invention also relates to a luminaire comprising the light guide according to the invention or comprising the illumination system according to the invention.

The invention also relates to a scanning backlight system comprising a plurality of light sources and comprising the light guide according to the invention or comprising the illumination system according to the invention. The illumination system and/or scanning backlight system may further comprise a diffuser and/or a brightness enhancement foil and/or a redirection foil to further improve the uniformity of the light emitted from the illumination system and/or scanning backlight system.

The invention also relates to a display device comprising the light-guide according to the invention, or comprising the scanning backlight system according to the invention.

### BRIEF DESCRIPTION OF THE DRAWINGS

These and other aspects of the invention are apparent from and will be elucidated with reference to the embodiments described hereinafter.

In the drawings:

FIGS. 1A to 1C are schematic three-dimensional views of light-guide segments according to the invention,

FIGS. 2A to 2C are schematic cross-sectional views of illumination systems or scanning backlight systems according to the invention,

FIG. 3A is a schematic three-dimensional view of a light-guide according to the invention, and FIG. 3B is a graph indicating the emitted luminance along a cross-section of the light-guide as shown in FIG. 3A,

FIG. 4 is a schematic top-view of a light-guide comprising a two-dimensional array of light-guide segments, and

FIGS. 5A and 5B are schematic cross-sectional views of a display device and a luminaire, respectively.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

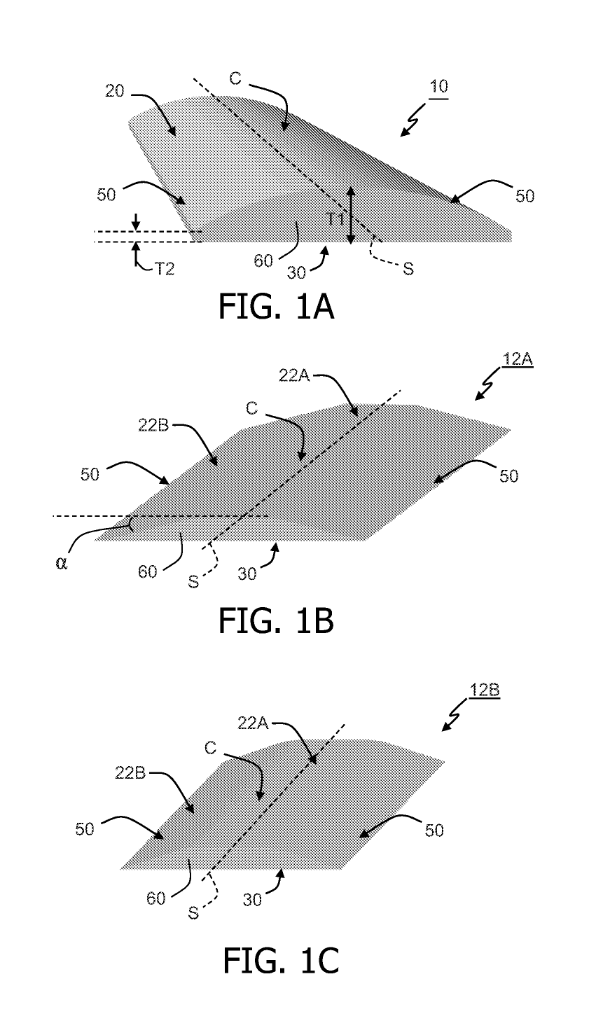

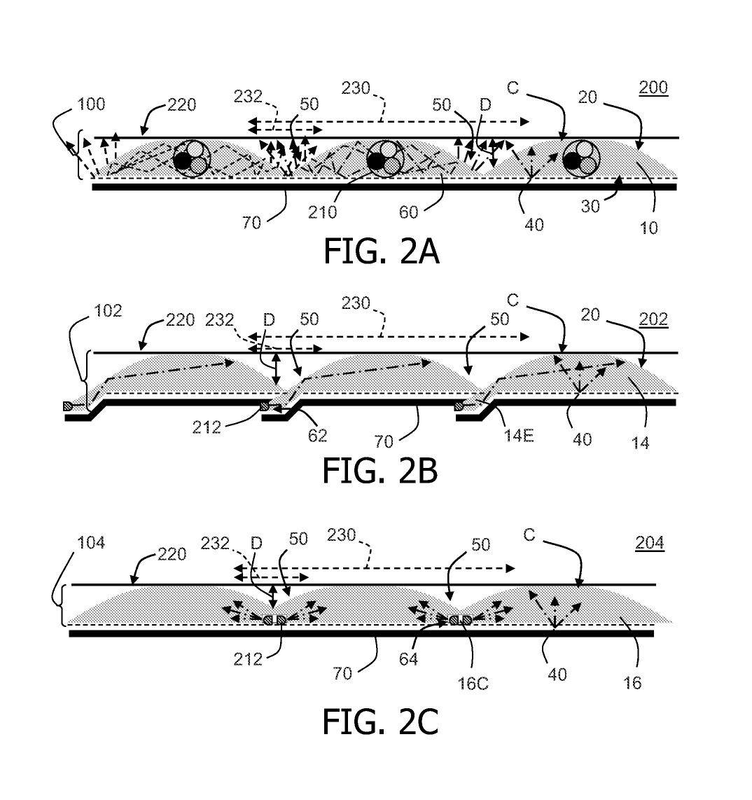

FIGS. 1A to 1C are schematic three-dimensional views of light-guide segments 10, 12A, 12B according to the invention. The light-guide segments 10, 12A, 12B shown in FIGS. 1A to 1C comprise a front wall 20, 22A, 22B arranged opposite a rear wall 30 between which light is guided, for example, via total internal reflection between the front wall 20, 22A, 22B and the rear wall 30. The front wall 20, 22A, 22B comprises a predefined edge 50 which has a reduced thickness T2 compared to the thickness T1 of the light-guide segment 10, 12A, 12B at a center C of the light-guide segment 10, 12A, 12B. The thickness T1, T2 of the light-guide segment 10, 12A, 12B is a distance between the front wall 20, 22A, 22B and the rear wall 30 measured in a direction substantially perpendicular to the light output window 220 (see FIGS. 2A to 2C). Due to this reduced thickness T2 at the predefined edge 50, the distance D (see FIGS. 2A to 2C) between the front wall 20, 22A, 22B and the light output window 220 is increased. The effect of such increase in distance D between the predefined edge 50 of the front wall 20, 22A, 22B and the light output window 220 compared to the center C of the front wall 20, 22A, 22B is that variations in intensity and/or color and/or distribution of the light emitted by neighboring light-guide segments are reduced at the light output window 220. The thickness T1, T2 of the light-guide segment 10, 12A, 12B may, for example, be at least 3 times larger at the center C of the front-wall 20, 22A compared to the thickness T2 at the predefined edge 50. This difference in thickness T1, T2 causes an efficient confinement of light within the individual light-guide segments 10, 12A, 12B when the light-guide segments 10, 12A, 12B are arranged in a light-guide 100, 102, 104 (see FIGS. 2A to 2C) comprising a plurality of light-guide segments 10, 12A, 12B and which is constituted by a continuous material.

The embodiments of the light-guide segments 10, 12A, 12B as shown in FIGS. 1A, 1B and 1C are light-guide segments 10, 12A, 12B which are configured to be arranged in a one-dimensional array of light-guide segments 10, 12A, 12B to form the light-guide 200, 202, 204. Such light-guide segment 10, 12A, 12B comprise a symmetry axis S and may comprise a light-entrance window 60 which is an edge-wall 60 intersecting with the symmetry axis S or part of the edge-wall between the front wall 20, 22A, 22B and the rear wall 30. The light-guide segments 10, 12A, 12B may, for example, be constituted by solid material substantially transparent for the light which is to be guided by the light-guide segments 10, 12A, 12B. The guiding and mixing of the light may, for example, occur via total internal reflection which generates a substantially loss-less confinement of the light inside the light-guide segment 10, 12A, 12B. Light may be extracted via light-extraction means 40 (see FIGS. 2A to 2B) distributed at the rear wall 30 or throughout the light-guide segment 10, 12A, 12B (not shown).

FIG. 1A comprises an illustration of a light-guide segment 10 in which the shape of the front wall 20 comprises a smoothly curved shape 20. The smoothly curved shape 20 is configured for increasing the distance D between the front wall 20 and the light output window 220 at the predefined edge 50 compared to the center C of the front wall 20. This smoothly curved shape has as an advantage that it prevents any abrupt changes in the front wall 20 which may comprise additional scattering elements and which may cause non-uniformities in the emission profile of the light emitted from the light-guide segment 10. A further advantage of the smoothly curved shape 20 is that well known production techniques such as injection molding techniques or extrusion techniques may be used to manufacture the light-guide 200 or to manufacture the individual light-guide segments 20 which reduces production cost of the light-guide 200 and of the individual light-guide segments 20.

The light-guide segment 10 as shown in FIG. 1A also comprises an edge wall between the predefined edge 50 and the rear wall 30 (indicated in FIG. 1A between the dashed lines indicating the reference T2). This edge wall may be used to increase a thickness of the light-guide segment 10 at the edge of the light-guide segment 10 to make the light-guide segment 10 less vulnerable for damage.

FIGS. 1B and 1C comprise an illustration of a light-guide segment 12A, 12B in which the shape of the front wall 22A, 22B comprises a plurality of facets 22A, 22B. The plurality of facets 22A, 22B comprises an edge-facet 22B which comprises the predefined edge 50. The edge-facet 22B is arranged at an angle with the light output window 220 (see FIGS. 2A to 2C) for increasing the distance D. The use of the edge-facet 22B causes the increased distance between the front wall 22A, 22B and the light output window 220 to gradually increase, defined by the angle between the edge-facet 22B and the light output window 220. Such gradual increase of the distance D further reduces the visibility of any remaining differences in intensity and/or color and/or distribution of the light emitted by adjacent light-guide segments 12A, 12B when the light-guide segments 12A, 12B are arranged in an array of light-guide segments 12A, 12B for together illuminate the light output window 220. The angle between the edge-facet 22B and the light output window 220 is, for example, within a range between (and including) 10 degrees and 30 degrees (10 to 30) to ensure sufficient distance D between the predefined edge 50 and the light output window 220 while preventing a too steep variation of the distance D. In the embodiments of the light-guide segment 12A, 12B as shown in FIGS. 1B and 1C, the front wall 22A, 22B comprises, next to the edge-facet 22B only a single center-facet 22A at the center C of the light-guide segment 12A, 12B. However, it will be apparent to the skilled person that additional facets may be present in the light-guide segment 12A, 12B without departing from the scope of the invention. Also in the light-guide segment 10 as shown in FIG. 1A the front wall 20 may comprise a substantially flat facet (shown in FIGS. 2A, 2B and 2C), for example, in the center C of the front wall 20 in which such flat facet may, for example, be arranged parallel to the rear wall 30.

The light-guide segments 12A, 12B as shown in FIGS. 1B and 1C may also comprise an edge wall (not indicated) as indicated in FIG. 1A at the reference T2. Such edge wall may be constituted by a wall or facet arranged substantially perpendicular to the light output window 220 or perpendicular to the rear wall 30 and may be arranged between, for example, the edge-facet 22B and the rear wall 30. Such an edge wall increases the thickness and the strength of the light-guide segment 12A, 12B near the edge of the light-guide segment 12A, 12B or the light-guide 100, 102, 104 which makes the light-guide segment 12A, 12B less vulnerable for damages at the edge of the light-guide segment 12A, 12B. If no edge wall is present at the edge-facet of the front wall 22A, 22B, the thickness of the light-guide segment 12A, 12B at the front wall 22A, 22B would be very narrow which would increase the risk that parts of the light-guide segment 12A, 12B may be damaged and break off, for example, during assembly of the light-guide 100, 102, 104.

FIGS. 2A to 2C are schematic cross-sectional views of illumination systems 200, 202, 204 or scanning backlight systems 200, 202, 204 according to the invention comprising a light-guide 100, 102, 104 which comprise the light-guide segments 10, 14, 16. The light-guides 100, 102, 104 shown in FIGS. 2A to 2C comprise an array of light-guide segments 10, 14, 16 which together illuminate the light output window 220. The light output window 220 may be a window constituted by translucent material through which the light-guide 100, 102, 104 emits its light in operation away from the light-guide 100, 102, 104. Alternatively, the light output window 220 may, for example, comprise an imaginary planar surface which, for example, may be a tangent plane contacting the front wall 20 substantially at the center C of the front wall 20 or an imaginary planar surface which is substantially parallel to the tangent plane which contacts the front wall 20 substantially at the center C of the front wall 20. At the edge 50 where one light-guide segment 10, 14, 16 adjoins a neighboring light-guide segment 10, 14, 16 in the array of light-guide segments 10, 14, 16—further indicated as predefined edge 50—illumination differences may occur at the light output window 220. The light-guide segments 10, 14, 16 are configured to reduce these illumination differences by increasing the distance D between the front wall 20 and the light output window 220 at and near the predefined edge 50 compared to the distance D between the front wall 20 and the light output window 220 at the center of the front wall 20.

The light-guide segment 10, 14, 16 may comprise light extraction means 40 to ensure that the light confined inside the light-guide segment 10, 14, 16 may be extracted from each light-guide segment 10, 14, 16 such that the light output window 220 of the illumination system 200, 202, 204 is illuminated substantially homogeneously. When the illumination system 200, 202, 204 is a scanning backlight system 200, 202, 204 the light intensity which impinges on the light output window 220 is substantially homogeneous across the light output window 220 during a predefined time interval which may, for example, be a frame time of a display device 300 such as a television 300.

The illumination system 200, 202, 204 as shown in FIGS. 2A to 2C comprise the light guide segment 10, 14, 16 and a reflecting layer 70 for reflecting light which is extracted from the light-guide 100, 102, 104 but progresses away from the light output window 220 back to the light output window 220. The illumination system 200, 202, 204 further comprises a light source 210, 212 in which each light-guide segment 10, 14, 16 comprises a separate light source 210, 212 which emits light into the light-guide segment 10, 14, 16. This combination of light source 210, 212 and light-guide segment 10, 14, 16 is required when the light-guide 100, 102, 104 is used in a scanning backlight system 200, 202, 204 in which parts 230 of the light output window 220 is sequentially illuminated by corresponding light-guide segments 10, 14, 16. The illumination of the corresponding parts 230 by the light-guide segments 10, 14, 16 further comprises an overlap region 232 in which light of the light-guide segment 10, 14, 16 and its neighboring light-guide segment 10, 14, 16 overlaps. The distribution of the light-extraction means 40 may be chosen such that the intensity of each of the individual light-guide segments 230 at the overlap region 232 is lower such that eventually, when adding the contribution of the light emitted by the light-guide segment 10, 14, 16 to the light emitted by the adjacent light-guide segment 10, 14, 16, the overall illumination across the light output window 220 is substantially constant.

The illumination system 200 as shown in FIG. 2A comprises a light-guide 100 constituted of a linear array of light-guide segments 10 which have a substantially smoothly curved front layer 20 for emitting light towards the light output window 220. The center part C of the smoothly curved front layer 20 may comprise a relatively flat region as indicated in the illumination systems 200, 202, 204 of FIGS. 2A, 2B and 2C. The edge wall 60 is also used as light entrance window 60 for allowing light emitted by the light source 210 to enter the light-guide segment 10 after which the light is preferably guided by the light-guide segment 10 via total internal reflection. The light source 210 comprises a plurality of light emitters (indicated with three circles inside the light source 210), which each, for example, emit white light or a different color into the light-guide segment 10. Such a light source 210 comprising a plurality of light emitters emitting a different color enables to adapt the color of the light which is mixed and distributed inside the light-guide segment 10 and which is subsequently emitted from the light-guide 100. Furthermore, the plurality of light emitters enables to, for example, emit the different colors from the light-guide segments 10, for example, selectively or sequentially, allowing a broad range of illumination sequences to be performed by the light-guide 100. In the embodiment shown, the rear wall 30 is a substantially straight wall 30 arranged parallel to the light output window 220, but substantially any other shape of the rear wall 30 may be used. The predefined edge 50 is arranged at a distance D from the light output window 220 to ensure enhanced mixing of the light emitted from the light-guide segment 10 and from an adjacent light-guide segment 10 to reduce any illumination difference between adjacent light-guide segments 10.

The illumination system 202 as shown in FIG. 2B comprises a light-guide 102 which is constituted of an array of light-guide segments 14 in which each light-guide segment 14 comprises a light-guide extension 14E which comprises the light-entrance window 62 and which enables the light-entrance window 62 together with the light source 212 to be arranged at the rear wall 30 of the neighboring light-guide segment 14 out of sight. Due to this arrangement of the light source 212, the light-guide segments 14 of the light-guide 102 as shown in FIG. 2B may be arranged in a linear array of light-guide segments 14 or may be arranged in a two-dimensional array of light-guide segments 14. The front wall 20 extends from the light-guide extension 14E to the part of the light-guide segment 14 facing the light output window 220. Only the part of the front wall 20 which faces the light output window 220 is used to extract light from the light-guide segment 14 to illuminate the light output window 220. The light source 212 may, for example, be a light emitting diode 212 or any other light source 212 suitable for emitting light into the light-guide segment 14.

The illumination system 204 as shown in FIG. 2C comprises a light-guide 104 which comprises a concavely shaped part 16C bulging inward into the light-guide segment 16, for example, from the rear wall 30 or at an edge of the light-guide segments 16 (as shown in FIG. 2C) to accommodate room for the light source 212. Such light source 212 may, for example, be a side-emitting light emitting diode 212 or a light emitting diode 212. The light from the light source 212 may, for example, be emitted in a direction substantially parallel to the light output window 220. The light-entrance window 64 is at least part of the interface between the concavely shaped part 16C and the light-guide segment 16. Also this arrangement of the light-source 212 enables the light-guide segments 16 to be arranged in a linear array of light-guide segments 16 or in a two-dimensional array of light-guide segments 16.

As can be clearly seen from the cross-sectional views of FIGS. 2A to 2C, the distance D between the front wall 20 and the light output window 220 is larger at the predefined edge 50 compared to the center C of the front wall 20. The effect of the illumination system 200, 202, 204 comprising the light-guide 100, 102, 104 according to the invention is that the increased distance D at the predefined edge 50 causes local variations in intensity and/or color and/or distribution of the light which is emitted at or near the predefined edge 50 to be reduced due to improved mixing of the light emitted from the predefined edge 50 by adjacent light-guide segments 10, 14, 16 before this emitted light impinges on the light output window 220.

The light-guides 100, 102, 104 as shown in FIGS. 2A to 2C may be constituted by a continuous material. The increased distance at the predefined edge 50 of each of the light-guide segments 10, 14, 16 causes the optical separation of light guided in the individual light-guide segments 10, 14, 16. Such a light-guide 100, 102, 104 may be produced via well known injection-molding techniques, stamping or extrusion techniques. Because no alignment of the individual light-guide segments 10, 14, 16 is required, no gap occurs between the individual light-guide segments 10, 14, 16, further reducing any light-artifacts between two adjacent light-guide segments 10, 14, 16.

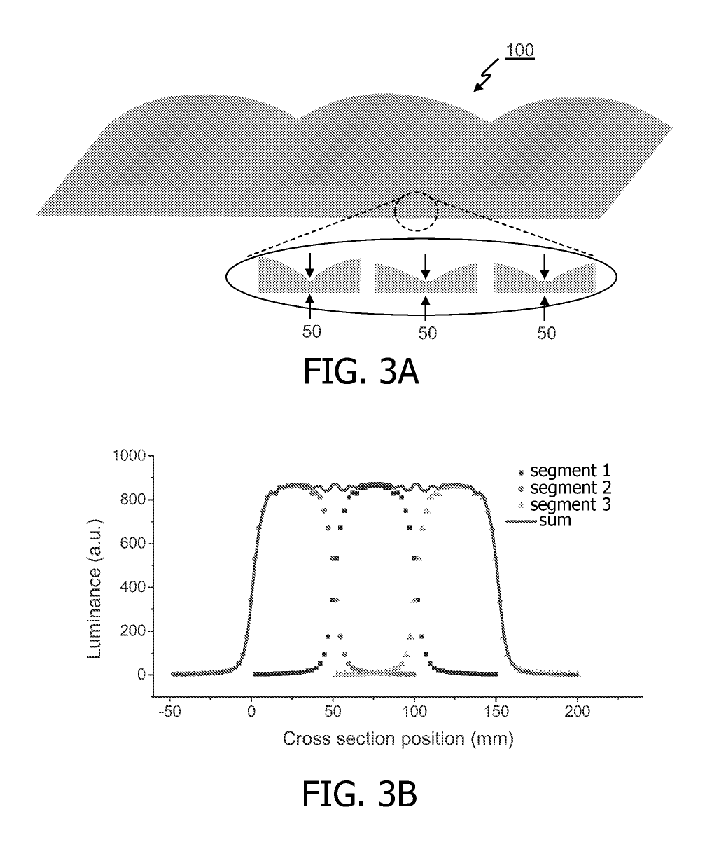

FIG. 3A is a schematic three-dimensional view of a light-guide 100 according to the invention. In the embodiment of the light-guide 100 of FIG. 3A, the light output window has been omitted for clarity reasons. FIG. 3A clearly illustrates that the light-guide 100 may be manufactured from a continuous material in which different transitions between the individual light-guide segments 10 are indicated in the enlarged detail of the light-guide 100 shown in FIG. 3A. These different transitions result in different illumination profiles at the light output window 220 and may require a different distribution of the light-extraction means 40 to ensure that the light distribution across the light output window 220 remains substantially homogeneous. The redefined edge 50 substantially coincides with the border between two neighboring light-guide segments 10 which is indicated with two arrows pointing towards each other in the enlarged details. Between two neighboring light-guide segments 10 even a relatively flat region may be present (see most right of the three enlarged details) in which case the predefined edge 50 is arranged substantially in the center of the relatively flat region (again indicated with the two arrows pointing towards each other).

FIG. 3B is a graph indicating the emitted luminance along a cross-section of the light-guide 100 as shown in FIG. 3A. For this graph, a specific distribution of the light-extraction means 40 is required which may lead to a substantially uniform illumination of the light output window 220 by the light-guide 100 comprising individual light-guide segments 10. As can be clearly seen from the graphs indicating the individual light emission profiles of the individual light-guide segments 10, there is a predefined overlap region 232 in which the light of neighboring light-guide segments 10 overlap to average out any illumination differences between the individual light-guide segments 10. Due to the increased distance D at the predefined edge 50, the light of the different light-guide segments 10 is mixed before illuminating the light output window 220 to average out any illumination differences and reducing the visibility of any illumination artifacts. Also local scattering and/or misalignment between two adjacent light-guide segments 10 is reduced due to this increased distance D and the predefined overlap region 232.

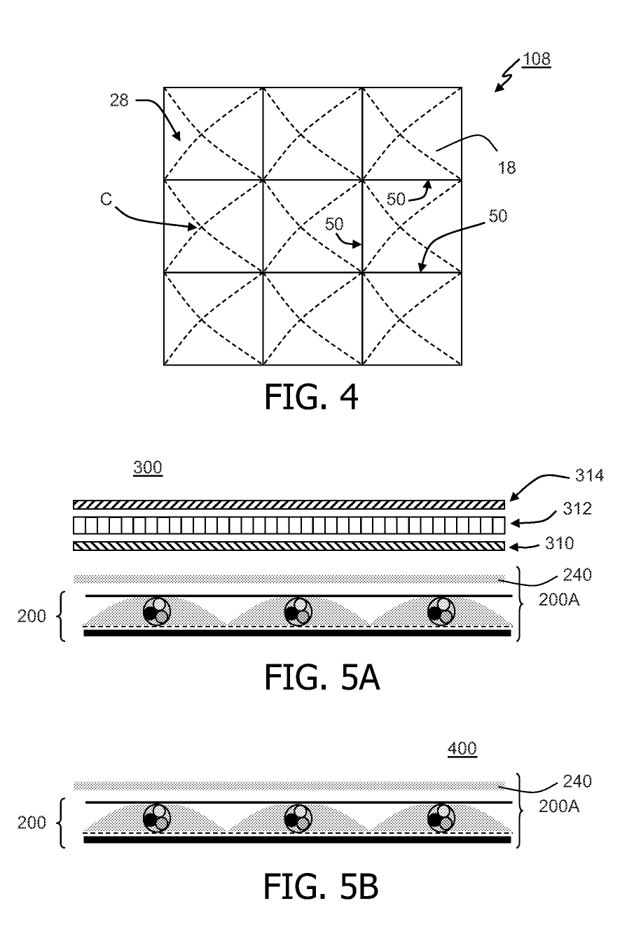

FIG. 4 is a schematic top-view of a light-guide 108 comprising a two-dimensional array of light-guide segments 18. The individual light-guide segments 18 may, for example, correspond in a cross-sectional view to the light-guide segments 14, 16 as shown in FIGS. 2B and 2C. In such two-dimensional array of light-guide segments 18 the front wall 28 may have a substantially cushion form, and every light-guide segment 18 has typically more than two adjacent light-guide segments 18—and thus more than two predefined edges 50 of the front wall 28.

FIGS. 5A and 5B are schematic cross-sectional views of a display device 300 and a luminaire 400, respectively. The display device 300 as shown in FIG. 5A may, for example, be a liquid crystal display device 300 which comprises a layer of electrically connected (not shown) liquid crystal cells 312, a polarizing layer 310, and an analyzing layer 314. Alternatively, the display device 300 may be any other non-emissive display device 300. The display device 300 comprises the scanning backlight system 200A comprising the illumination system 200 as shown in FIG. 2A. The scanning backlight system 200A further may comprise a diffuser layer 240. The diffuser layer 240 may constitute the light output window 220 of the illumination system 200. The diffuser layer 240 may also comprise luminescent material (not shown) or may comprise a mixture of luminescent materials (not shown).

FIG. 5B is a schematic cross-sectional view of the luminaire 400 which comprises the illumination system 200, together with the diffuser layer 240 or which comprises the illumination system 200A which includes the diffuser layer 240. The diffuser layer 240 may also comprise luminescent material (not shown) or may comprise a mixture of luminescent materials (not shown). The luminaire 400 may further comprise a housing (not shown) for applying the luminaire 400 to a wall or ceiling, and may further comprise beam-shaping elements (not shown) to generate a predefined light distribution in a room (not shown).

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A light-guide (100, 102, 104, 108) for an illumination system (200, 202, 204), the light-guide (100, 102, 104, 108) comprising a light output window (220) and comprising a plurality of light-guide segments (10, 12A, 12B, 14, 16, 18), each light-guide segment (10, 12A, 12B, 14, 16, 18) being substantially optically separated from a neighboring light-guide segment (10, 12A, 12B, 14, 16, 18), each light-guide segment (10, 12A, 12B, 14, 16, 18) comprising a front wall (20, 22A, 22B, 28) arranged opposite a rear wall (30) and being configured for distributing the light within the light-guide segment (10, 12A, 12B, 14, 16, 18), each light-guide segment (10, 12A, 12B, 14, 16, 18) further comprising light-extraction means (40) for extracting at least part of the distributed light via the front wall (20, 22A, 22B, 28) to illuminate in operation the light output window (220), a distance (D) between the front wall (20, 22A, 22B, 28) and the light output window (220) being smaller at a center (C) of the front wall (20, 22A, 22B, 28) compared to a predefined edge (50) of the front wall (20, 22A, 22B, 28), the predefined edge (50) of the front wall (20, 22A, 22B, 28) being an edge at which the light-guide segment (10, 12A, 12B, 14, 16, 18) is arranged adjacent to the neighboring light-guide segment (10, 12A, 12B, 14, 16, 18).

2. The light-guide (100, 102, 104, 108) as claimed in claim 1, wherein the light-guide (100, 102, 104, 108) is constituted by a continuous material, the increased distance (D) at the predefined edge (50) of each of the light-guide segments (10, 12A, 12B, 14, 16, 18) constituting the optical separation between the light-guide segments (10, 12A, 12B, 14, 16, 18).

3. The light-guide (100, 102, 104, 108) as claimed in claim 2, wherein a thickness (T1) of the light-guide segment (10, 12A, 12B, 14, 16, 18) at the center (C) of the front wall (20, 22A, 22B, 28) is at least 3 times larger than the thickness (T2) at the predefined edge (50) of the front wall (20, 22A, 22B, 28) for generating the increased distance (D) at the predefined edge (50).

4. The light-guide (100, 102, 104, 108) as claimed in claim 1, wherein a shape of the front wall (20, 22A, 22B, 28) comprises a smoothly curved shape (20) configured for increasing the distance (D) between the front wall (20, 22A, 22B, 28) and the light output window (220) at a predefined edge (50) compared to the distance (D) at the center (C).

5. The light-guide (100, 102, 104, 108) as claimed in claim 1, wherein a shape of the front wall (20, 22A, 22B, 28) comprises a plurality of facets (22A, 22B) constituting the front wall (20, 22A, 22B, 28), wherein the plurality of facets (22A, 22B) comprises an edge-facet (22B) comprising the predefined edge (50), the edge-facet (22B) being configured for being arranged at an angle (α) with the light output window (220) for increasing the distance (D).

6. The light-guide (100, 102, 104, 108) as claimed in claim 1, wherein the plurality of light-guide segments (10, 12A, 12B, 14, 16) is arranged in a one-dimensional array of light-guide segments (10, 12A, 12B, 14, 16), or wherein the plurality of light-guide segments (18) is arranged in a two-dimensional array of light-guide segments (18).

7. The light-guide (100, 102, 104, 108) as claimed in claim 1, wherein the light-guide segment (10, 12A, 12B, 14, 16, 18) comprises a light-entrance window (60, 62, 64) for enabling light from a light source (210, 212) to enter the light-guide segment (10, 12A, 12B, 14, 16, 18), at least one of the light-guide segments (10, 12A, 12B, 14, 16, 18) in the plurality of light-guide segments (10, 12A, 12B, 14, 16, 18) being configured for having the light-entrance window (62) located at a side of the rear wall (30) of the neighboring light-guide segment (10, 12A, 12B, 14, 16, 18) facing away from the neighboring light-guide segment (10, 12A, 12B, 14, 16, 18).

8. The light-guide (100, 102, 104, 108) as claimed in claim 1, wherein each light-guide segment (10, 12A, 12B, 14, 16, 18) is configured for illuminating a corresponding part (230) of the light output window (220), the corresponding parts (230) of neighboring light-guide segments (10, 12A, 12B, 14, 16, 18) are configured to partially overlap (232).

9. The light-guide (100, 102, 104, 108) as claimed in claim 8, wherein a distribution, dimension and/or density of the light-extraction means (40) in the light-guide segment (10, 12A, 12B, 14, 16, 18) is configured for reducing an intensity of the light extracted by a single light-guide segment (10, 12A, 12B, 14, 16, 18) at the overlap between neighboring parts illuminated by neighboring light-guide segments (10, 12A, 12B, 14, 16, 18) to generate a substantially uniform illumination of the output window (20).

10. The light-guide (100, 102, 104, 108) as claimed in claim 1, wherein the light-guide (100, 102, 104, 108) comprises luminescent material or comprises a mixture of luminescent materials for converting at least part of the light guided through the light-guide (100, 102, 104, 108) into light having a longer wavelength.

11. An illumination system (200, 202, 204, 200A) comprising a plurality of light sources (210, 212) and the light-guide (100, 102, 104, 108) as claimed in any of the claims 1 to 10.

12. The illumination system (200, 202, 204, 200A) as claimed in claim 11, wherein the plurality of light sources (210, 212) each emit substantially white light, and/or wherein the plurality of light sources (210, 212) comprise a plurality of light-emitters emitting light of a plurality of colors.

13. A luminaire comprising the light-guide as claimed in claim 1.

14. A scanning backlight system comprising a plurality of light sources and the light-guide as claimed in claim 1.

15. A display device comprising the light-guide as claimed in claim 1.

16. A luminaire comprising the illumination system as claimed in claim 11.

17. A scanning backlight system comprising a plurality of light sources and the illumination system as claimed in claim 11.

18. A display device comprising the scanning backlight system as claimed in claim 14.
